(19) United States
(12) Patent Application Publication
(10) Pub. No.: US 2025/0085189 A1
(43) Pub. Date: Mar. 13, 2025

(54) SYSTEM AND METHOD FOR FACADE OPERATIONS WITH ROBOTICS CARRIERS

(71) Applicant: The Chinese University of Hong Kong, Hong Kong (CN)

(72) Inventors: Darwin Tat Ming LAU, Hong Kong (CN); Dickson Chun Fung LI, Hong Kong (CN); Yue SUN, Hong Kong (CN); Chun Ming LEUNG, Hong Kong (CN)

(21) Appl. No.: 18/725,918

(22) PCT Filed: Jan. 6, 2023
(86) PCT No.: PCT/CN2023/070935

§ 371 Date: Jul. 1, 2024

Related U.S. Application Data
(60) Provisional application No. 63/266,515, filed on Jan. 6, 2022.

(51) Int. Cl. G01M 7/02; B25J 9/10; B25J 11/00; B25J 13/08

(52) U.S. Cl. CPC G01M 7/025; B25J 9/104; B25J 11/0075; B25J 13/088

(57) ABSTRACT

The present invention pertains to a system that can conduct building facade operations with an end effector. The robot system can include an end effector and a carrier platform. The end effector can travel to a position along a building facade to conduct the required tasks such as inspection or marking. The carrier platform can include a mobile chassis, a cable actuating mechanism, a cable routing system, and a fall protection system. The mobile chassis can move the carrier platform along a roof of a building or other site. The cable routing system together with the cable actuating mechanism can drive positioning and extension of the end effector. The coordinated motion of the mobile chassis and the cable actuating mechanism can enable adaption to the building geometries and features. A fall protection system can be incorporated to ensure the safety of the end effector.

### CROSS-REFERENCE TO RELATED APPLICATION

The present application claims the benefit of U.S. Provisional Application Ser. No. 63/266,515, filed Jan. 6, 2022, which is hereby incorporated by reference herein in its entirety, including any figures, tables, nucleic acid sequences, amino acid sequences, or drawings.

### BACKGROUND OF THE INVENTION

High-rise buildings are dominant in densely populated cities, such as Hong Kong, for both commercial and residential use. Inspection of such buildings is critical and can be performed periodically to ensure they are safe for both the occupants and the general public.

Currently, inspection is primarily conducted by capable operators and requires either scaffolding or gondolas. The operators have to tap the wall manually and search for the defect area. The “hollow” tapping sound represents a suspicious debonding area, and necessitates follow-up actions such as repairment. To label the debonding areas, operators should further mark the area with a marker, sprayer, or paint. However, such operations at height are dangerous for operators, frequently leading to injury or even death. Furthermore, the reliability and consistency of inspections, conducted by human operators involve judgment by subjective experience, leaving considerable room for improvements. Failures in conducting a reliable inspection can pose potential threats to the general public due to debris falling.

### BRIEF SUMMARY OF THE INVENTION

Embodiments of the present invention pertain to performance of building or structure facade operations. More particularly, embodiments of the subject invention provide a system and apparatuses capable of positioning an end effector with various tools (e.g., inspection tools and marking tools) for various operations including facade inspection and other facade operations. In certain embodiments, one or more robot carriers can locate on the roof of a building to deliver an end effector to a desired position of the facade. Certain embodiments can provide a chassis base and one or more motorized winches on the carrier platform, so that the end effector can be delivered to specified locations while avoiding the features and extrusions of the facade.

Embodiments provide a cable-driven robot system to perform physical contact-based facade operations including inspections. The robotic system can include a carrier platform for locomotion and an end effector for facade operation. One or more cable actuating mechanisms, (e.g., one or more winches) are installed in the carrier platform and can be configured to operate on the roof of a building. The cable actuating mechanism guides and drives the cables connected to the end effector, and the cables can drive the end effector to a desired position on the facade. The carrier platform can be fixed or mobile. The carrier platform can comprise a mobile chassis and coordinate with the actions of the winches to position the end effector. The system can also comprise an anchoring mechanism on either the carrier platform or the mobile chassis or both to provide a fixture or counteract the loading force for the carrier platform. The end effector can carry various tools, including inspection tools and marking tools to evaluate the concrete conditions and mark the defect areas at high risk of debonding. Apart from the direct marking on the surface of the area concerned, through analyzing the inspection data of the entire facade or one or more sections or defined areas, a concrete health report (optionally including a map, checklist, or inspection punch list) can be generated for the guidance of follow-up actions.

In certain embodiments for inspection tasks, certain inspection data can be digitally recorded and analyzed, while related art methods can rely on the subjective qualitative professional human judgment of debonding areas. Embodiments of the subject invention can provide a more accurate result with objective sensor-based quantitative measurements of the debonding area. Embodiments can advantageously reduce the learning curve for capable inspectors as compared to conventional hammer tapping tests.

Embodiments can provide a system that is easy to deploy, capable of inspecting large and uneven facade surfaces with various features and extrusions, safe to conduct precise inspections, and able to perform a wide range of non-contact or physical contact inspection tasks. In certain embodiments, the mobile chassis of the carrier platform allows convenient positioning of the end effector. The coordinated actions of the winch and mobile chassis can also allow adaptation of the buildings' features and obstacle avoidance to conduct inspections in undercut and uneven areas. The anchoring mechanism can provide a stable platform for the operation of the end effector. As compared to human operation, the robotic system can achieve a finer resolution while reaching inaccessible and dangerous areas, and can eliminate blind spots and risks of injuries. In certain embodiments, the carrier can carry different contact-based or non-contact-based sensors, including cameras, infra-red sensors, corrosion sensors, ultrasonic sensors, ground-penetrating radar (GPR), or impact echo sensors for inspection of facade conditions.

### BRIEF DESCRIPTION OF THE DRAWINGS

FIG. 1 illustrates a facade measurement system including an end effector, a carrier platform, and a ground station, according to an embodiment of the subject invention.

FIG. 2 shows the of an end effector, comprising multiple inspection tools, a marking tool, and stabilizing thrusters, according to an embodiment of the subject invention.

FIG. 3 shows the design of a carrier platform including motorized winches and a mobile chassis, according to an embodiment of the subject invention.

FIG. 4 shows the operation procedures of the robot inspecting undercut and uneven areas of a building facade, according to an embodiment of the subject invention.

FIG. 5 shows an annotated photo of a prototype of a carrier platform and an end effector, according to an embodiment of the subject invention.

FIG. 6 shows an annotated photo of a prototype of an end effector, according to an embodiment of the subject invention.

### DETAILED DISCLOSURE OF THE INVENTION

As used herein, the singular forms “a,” “an,” and “the” are intended to include the plural forms as well as the singular forms, unless the context clearly indicates otherwise. Thus, for example, reference to “an arm” or “a hole” should be construed to cover or encompass both a singular arm or a singular hole and a plurality of arms and a plurality of holes, unless indicated otherwise or clearly contradicted by the context. Similarly, for example, reference to multiple “arms” or any plurality of “holes” should be construed to cover or encompass both a singular arm or a singular hole and a plurality of arms and a plurality of holes, unless indicated otherwise or clearly contradicted by the context. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention pertains. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing embodiments of the invention, it will be understood that a number of techniques and steps are disclosed. Each of these has individual benefits and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

Novel and useful robotic system designs, apparatuses, and methods for facade inspection are disclosed herein. In the following description, for purposes of explanation, numerous specific details are set forth to provide a thorough understanding of the present invention. It will be evident, however, to one skilled in the art that embodiments of the present invention can be practiced without these specific details.

The present disclosure is to be considered as an exemplification of certain embodiments of the invention and is not intended to limit the invention to the specific embodiments illustrated by the figures or the description below.

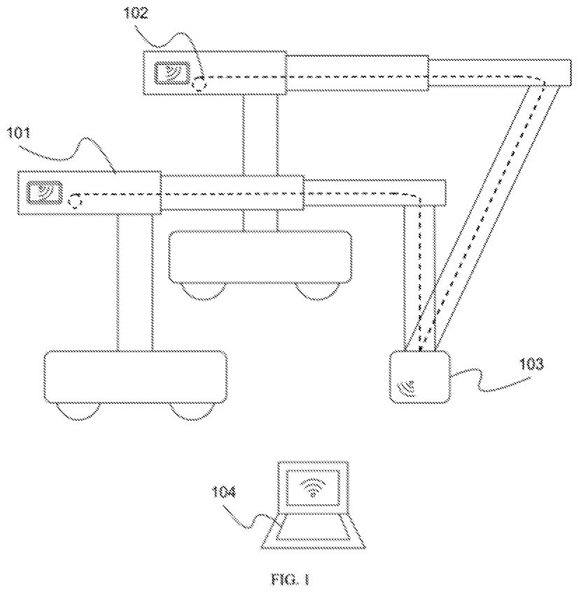

The present invention will now be described by referencing the appended figures representing certain exemplary and non-limiting embodiments. FIG. 1 depicts an isometric view of a system for conducting facade operation with the robotic system (the “system”) according to various embodiments of the present invention. FIG. 1 includes an end effector and a carrier platform.

Referring to FIG. 1, in the embodiment shown, the end effector can be suspended by one or more carrier platforms. Possible configurations include one end effector connected to one carrier platform or one end effector connected to two or more carrier platforms. Alternative configurations can include more than one end effector connected to one carrier platform or more than one end effector connected to two or more carrier platforms. Exemplary and non-limiting embodiments can provide 1, 2, 3, 4, 5, or more carrier platforms working separately or together in sequential or parallel configuration, or combinations thereof, as appropriate to the size and confirmation of the building and the carrier platforms, to support and position 1, 2, 3, 4, 5, or more end effectors. The end effector 103 can be suspended by the motorized winches with one or more cables 102 connected. The motorized winch can be mounted at the carrier platform 101. By controlling the cables with the motorized winches and the carrier platforms, the end effector can be delivered to the desired positions on the facade. Tasks including inspection of the external wall surface can be conducted by the inspection tools. Digitized data can be recorded and sent to the ground station 104 for analysis.

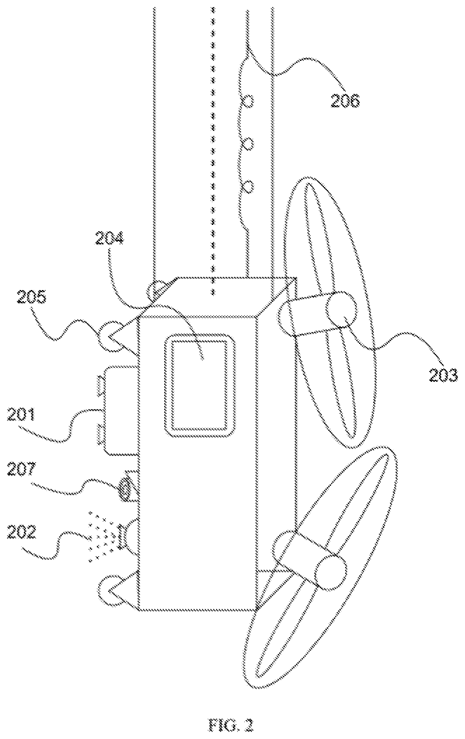

FIG. 2 provides an enlarged view of one embodiment of an end effector, containing the inspection tools 201, marking tool 202, and additional features 205 to enable facade inspection of a variety of buildings with different extrusions or geometries.

Inspection tools 201 can be used to determine thickness or to locate cracks, voids, and other defects in masonry structures where the brick or block units are bonded together with mortar. In certain embodiments of the inspection tools, sensors 201 can measure the concrete health in a non-destructive way. In certain embodiments the inspection tools and the marking tool can be delivered to the surface of the facade during the inspection process for contact-based operations. The contact sensor 205 can ensure gentle contact with the desired distance to the wall surface.

For some facade operation procedures, visible marks would be made to indicate the defects after identification of a debonding area or an operating location. A marking tool 202, as an option, can be incorporated into the end effector. In certain embodiments a paint reservoir is provided in the carrier platform or the end effector.

For various contact-based operations including inspection and maintenance works, a stable structure is essential to ensure high-quality outcomes. In certain embodiments thrusters 203 can be incorporated into the end effector to provide extra stability. Thrusters can provide extra thrust forces on the robot to maintain stable contact with the wall surface and mitigate the effect of external disturbances including wind and unexpected contact forces. The thrust force directions and thruster attachment positions can be reconfigured to provide desired forces required in various scenarios. The means of reconfiguring the thruster can include motors, pneumatic actuators, solenoids, or smart material actuators, as well as other actuators, attachments, and positioning systems know in the art.

In certain embodiments various sensors 204 can be used to position the robot and map the building facade features. Sensors, transmitters, or receivers can be placed on the carrier platform or the end effector to determine the relative position between the robotic platform and the winches. Machine vision elements 207 can also be incorporated into the robotic platform to provide additional information for obstacle avoidance. The camera images, provided by the cameras, can be sent to ground station 104 for operators monitoring. The robot operator can input the desired area to be inspected, together with the position control, the required trajectory can be calculated and implemented. In this manner, a high resolution of inspection with an advantageously efficient path can be performed.

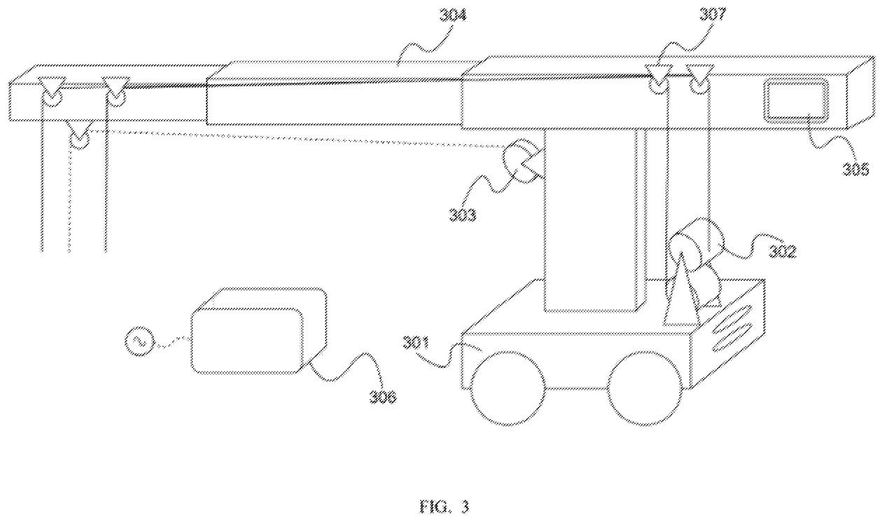

In FIG. 3 one embodiment of a carrier platform is depicted. The carrier platform can drive one or more cables. Each cable can be attached to a cable actuation unit 302 that controls the cable length and drives the end-effector to a certain position. The end effector and the carrier platform can be arranged in various configurations (e.g., including the configuration shown in FIG. 1.)

FIG. 3 provides an enlarged view of the carrier platform, consisting of chassis 301, winches 302, and the fall arresting system 303. The winches 302 can realize elevation control of the end effector 103 (as shown in FIG. 1.) A pair of cables, a single cable, or a multitude of cables can suspend the end effector with the drum of the winches for driving the end effector to different positions of the facade. By controlling the length of the suspending cables, the elevation of the end effector can be precisely controlled. Fall arresting mechanism 303 can be optionally incorporated to capture the end effector in case of accidents. The form of the fall arresting mechanism can be a load arrestor or anti-tilting mechanism depending on the real site scenario.

A set of pulleys 307 is adopted to route the cable from the winch to a desired cable outlet position (e.g., to a position that will lower the center of mass of the robot for higher stability) minimizing the transportation effort, while maintaining a minimal effort of on-site setup. The chassis 301 enables the carrier platform to travel to a specified position on the roof, carrying the end effector to a desired horizontal position. The chassis can be omnidirectional such that a narrow space maneuver is achievable. The jib 304 can be telescopic, foldable or modular such that the length is adjustable to adapt and cater to different site features. The reach of the jib can be designed and selected subject to the facade features, roof environment, and total loading. The control interface 305 provides extra flexibility for the operators to monitor, debug and control the carrier platform beside the ground statin 104. Operators have the freedom to control locally attached equipment on the carrier platform. In certain embodiments a charging station 306 is also positioned at the roof, so that the working range of the system could considerably increase.

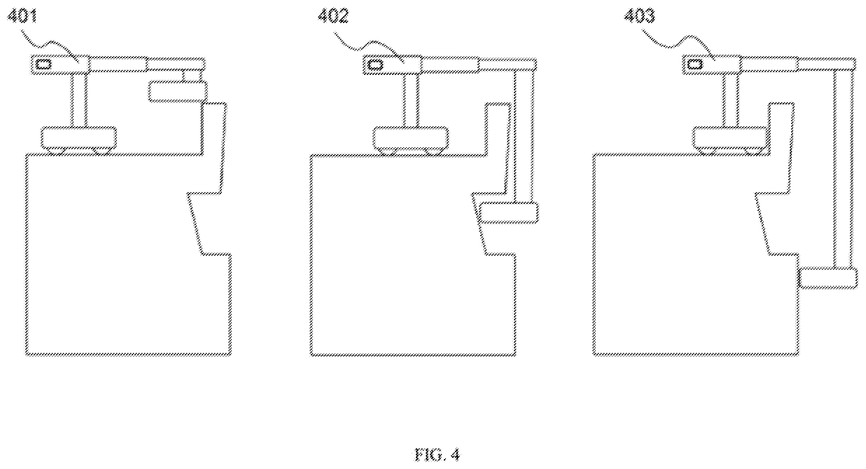

FIG. 4 illustrates one of the ways the system can perform facade features adaptation. The chassis can adjust the distance between the end effector and the parapet wall surface, and can achieve obstacle avoidance and adapt to the building structure with various extrusions. During preparation stage 401, the end-effector is connected to the carrier platform and ready to hang out of the building. During a concave feature adaptation stage 402, the carrier platform can move away from the parapet wall such that end-effector, particularly the inspection tools 201, can reach the facade. During an extrusion adaptation stage 403, the carrier platform can move toward the parapet wall such that the end-effector can escape from the concave features.

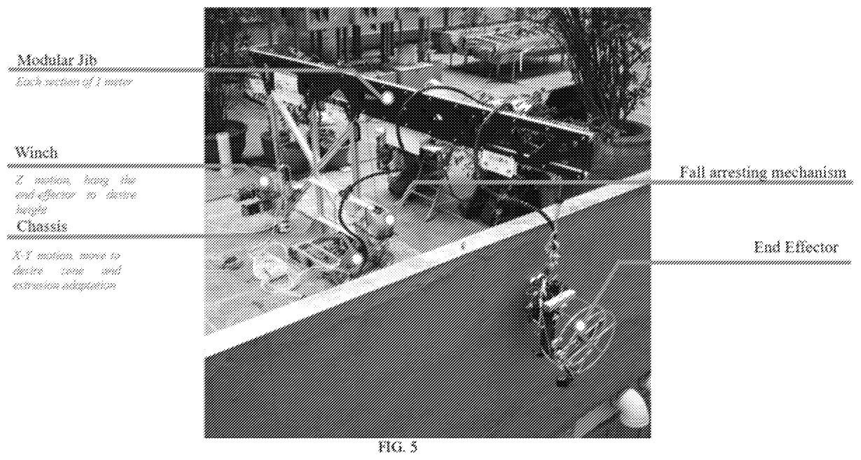

FIG. 5 a photo of a prototype of a carrier platform and an end effector, according to an embodiment of the subject invention. The carrier platform includes a modular jib with 1 meter sections. A winch is provided to drive Z motion and hang the end-effector to desired height. A chassis is provided to drive X-Y motion and move to desired zone and extrusion adaptation. A fall arresting mechanism is provided to inhibit the end effector from falling. An end effector is shown in position along a facade surface.

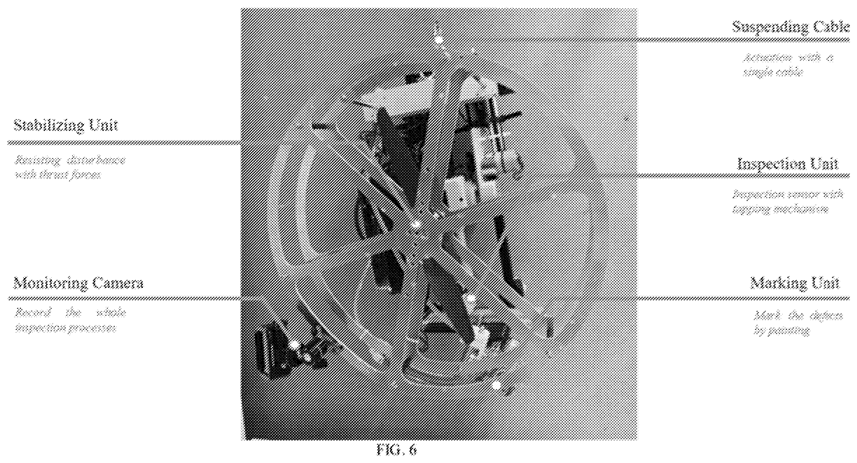

FIG. 6 shows an annotated photo of a prototype of an end effector, according to an embodiment of the subject invention. A stabilizing unit is provided to resist disturbance with thrust forces. In this embodiment the stabilizing unit comprises a propeller for producing thrust force. A monitoring camera is provided to record the whole inspection process, or selected elements of the inspection process. A suspending cable is provided for actuation with a single cable. An inspection unit is provided, including an inspection sensor with tapping mechanism. A marking unit is provided to mark defects by painting.

A greater understanding of the embodiments of the subject invention and of their many advantages may be had from the following non-limiting and exemplary embodiments, given by way of illustration. The following examples are illustrative of some of the methods, applications, embodiments, and variants of the present invention. They are, of course, not to be considered as limiting the invention. Numerous changes and modifications can be made with respect to embodiments of the invention.

Embodiment 1. A robotic system for facade operation of a building facade with an irregular surface, different features, and extrusions, the system comprising:
a suspended end effector cooperating with one or more cables for positioning the end effector along the building facade;
one or more carrier platforms, each carrier platform configured to drive one or more cables to deliver the end effector to one or more specified positions along the building facade;
a controller cooperating with the end effector and at least one carrier platform to drive at least two cables to deliver the end effector to one or more specified positions along the building facade.

Embodiment 2. The system of Embodiment 1, wherein the at least two cables each span between the end effector and a carrier platform located on a building roof.

Embodiment 3. The system of Embodiment 1, further comprising one or more facade inspection sensors positioned on the end effector.

Embodiment 4. The system of Embodiment 3, wherein one or more signal generators selected from the group containing an impact generator, an ultrasonic emitter, and electromagnetic wave emitter, are positioned on the carrier and configured to generate signals to facilitate inspection of the facade.

Embodiment 5. The system of Embodiment 3, further comprising a marking tool positioned on the end effector to mark on the facade.

Embodiment 6. The system of Embodiment 5, further comprising a stabilizing mechanism on the end effector, the stabilizing mechanism configured to stabilize the carrier with respect to the facade.

Embodiment 7. The system of Embodiment 5, further comprising a stabilizing mechanism on the end effector, the stabilizing mechanism configured provide a force sufficient to activate a contact mechanism on the inspection sensor.

Embodiment 8. The system of Embodiment 6, further comprising a reconfigurable mechanism to adjust the direction and position of the stabilizing forces.

Embodiment 9. The system of Embodiment 8, further comprising a locomotion mechanism positioned on the carrier platform configured to generate locomotion of the system.

Embodiment 10. The system of Embodiment 1, further comprising a cable actuating mechanism positioned on the carrier platform for actuating the at least two cables.

Embodiment 11. The system of Embodiment 10, further comprising a cable routing mechanism to route the at least two cables between the cable actuating mechanism and the end effector.

Embodiment 12. The system of Embodiment 5, wherein the marking tool comprises a material applicator.

Embodiment 13. The system of Embodiment 12, further comprising a reservoir and pumping system positioned on the carrier or the carrier platform to deliver materials to the marking tools.

Embodiment 14. The robotic system of Embodiment 1, further comprising one or more positional sensors positioned on the carrier or the carrier platform to provide relative positional feedback for a coordinated motion.

Embodiment 15. The system of Embodiment 1, further comprising a fall protection mechanism positioned on the carrier platform to configured to inhibit the end effector from falling.

Embodiment 16. The system of Embodiment 1, further comprising an anchoring mechanism on the carrier platform configured to provide fixtures to the carrier platform.

Embodiment 17. A method of facade operation of a building facade with an irregular surface, different features, and extrusions, the method comprising using the system of claim 9 to mark a specified area of the facade by the marking tool according to a feedback signal of the facade inspection sensor.

Embodiment 18. The method of Embodiment 17, comprising coordinating the motion of the locomotion mechanism and the at least two cables for adaption of the system to building geometries.

Embodiment 19. The method of Embodiment 18, comprising acquiring visual images of the building facade, converting the images into virtual models, and using the virtual models to guide the inspection and indicate one or more specific areas of interest for inspection.

Embodiment 20. The method of Embodiment 19, comprising distributing one or more specific areas of interest for inspection into the virtual models of the building facade.

It should be understood that the examples and embodiments described herein are for illustrative purposes only and that various modifications or changes in light thereof will be suggested to persons skilled in the art and are to be included within the spirit and purview of this application and the scope of the appended claims.

### MATERIALS AND METHODS

All patents, patent applications, provisional applications, and publications referred to or cited herein are incorporated by reference in their entirety, including all figures and tables, to the extent they are not inconsistent with the explicit teachings of this specification.

Following are examples that illustrate procedures for practicing embodiments of the invention. These examples should not be construed as limiting. All percentages are by weight and all solvent mixture proportions are by volume unless otherwise noted.

### Example 1

A prototype cable-driven robot system to perform facade operations in accordance with an embodiment of the subject invention is presented. The robotic system consists of the carrier platform for locomotion and an end effector for inspection operations. The carrier platform is located on the roof of the facade, which guides and drives the cables connected to the end effector. The cables can drive the robotic platform to a specified position of the facade for inspection. The end effector consists of inspection tools and marking tools to evaluate the concrete status and mark the defects.

The locomotion of the end effector can rely on the carrier platform. The carrier platform drives the end effector, carries various auxiliary equipment, and integrates with the user interface. It locates on the roof of the building to be inspected while moving to different positions when necessary. It is comprised of a set of motorized winches and a mobile chassis. The end effector and the carrier platform prototype are arranged in the configuration as shown in FIG. 5.

The winches can realize elevation control of the end effector. A pair of cables or a single cable can suspend the end effector with the drum of the winches for driving the end effector to different positions of the facade. By controlling the length of the suspending cable, the elevation of the end effector can be precisely controlled. A set of pulleys is adopted to route the cable from the winch to a desired cable outlet position and lower the center of mass of the robot for higher stability. A fall arresting mechanism is further incorporated to protect the end effector from falling. The horizontal position can be adjusted by maneuvering the whole carrier platform. The chassis enables the carrier platform to travel to a specified position on the roof, carrying the end effector to a desired horizontal position. The chassis can adjust the distance between the end effector and the wall surface, which can achieve obstacle avoidance and adapt to the building with various extrusions and fringes.

The end effector is suspended by a cable connected to the motorized winch with the safety wire of the fall arresting mechanism attached. It can be driven to a desired position of the facade to carry out the required tasks. FIG. 6 provides a front view of the prototype end effector, containing the inspection tool, marking tool, and a thruster-based stabilizer to enable facade inspection of a variety of buildings with different geometries.

The inspection tool is responsible for the facade inspection. A non-destructive inspection tool can be used to determine the location and extent of flaws such as cracks, delaminations, voids, honeycombing, and debonding in plain, reinforced, and concrete structures with different surface finishing. Certain inspection data can be digitally recorded and analyzed. Visible marks can be made to indicate the defects, after identification of debonding areas or other concerns. A solenoid valve-controlled spraying gun is incorporated into the end effector for marking. Both visible marks and a digital report of the status of the concrete can be made to indicate the defects of the facade.

For various contact-based operations including inspection, and maintenance works, a stable structure is helpful to ensure high quality. The thruster is incorporated into the end effector to provide extra stability. It can provide an extra thrust force on the robot to maintain stable contact with the wall surface and mitigate the effect of external disturbance including wind and unexpected contact force.

It should be understood that the examples and embodiments described herein are for illustrative purposes only and that various modifications or changes in light thereof will be suggested to persons skilled in the art and are to be included within the spirit and purview of this application and the scope of the appended claims. In addition, any elements or limitations of any invention or embodiment thereof disclosed herein can be combined with any and/or all other elements or limitations (individually or in any combination) or any other invention or embodiment thereof disclosed herein, and all such combinations are contemplated with the scope of the invention without limitation thereto.

1. A robotic system for facade operation of a building facade with an irregular surface, different features, and extrusions, the system comprising:
a suspended end effector cooperating with one or more cables for positioning the end effector along the building facade;
one or more carrier platforms, each carrier platform configured to drive one or more cables to deliver the end effector to one or more specified positions along the building facade; and
a controller cooperating with the end effector and at least one carrier platform to drive at least two cables to deliver the end effector to one or more specified positions along the building facade.

2. The system of claim 1, wherein the at least two cables each spans between the end effector and a carrier platform located on a building roof.

3. The system of claim 1, further comprising one or more facade inspection sensors positioned on the end effector.

4. The system of claim 3, wherein one or more signal generators selected from the group containing an impact generator, an ultrasonic emitter, and electromagnetic wave emitter, are positioned on the carrier and configured to generate signals to facilitate inspection of the facade.

5. The system of claim 3, further comprising a marking tool positioned on the end effector to mark on the facade.

6. The system of claim 5, further comprising a stabilizing mechanism on the end effector, the stabilizing mechanism configured to stabilize the carrier with respect to the facade.

7. The system of claim 5, further comprising a stabilizing mechanism on the end effector, the stabilizing mechanism configured provide a force sufficient to activate a contact mechanism on the inspection sensor.

8. The system of claim 6, further comprising a reconfigurable mechanism to adjust the direction and position of the stabilizing forces.

9. The system of claim 8, further comprising a locomotion mechanism positioned on the carrier platform configured to generate locomotion of the system.

10. The system of claim 1, further comprising a cable actuating mechanism positioned on the carrier platform for actuating the at least two cables.

11. The system of claim 10, further comprising a cable routing mechanism to route the at least two cables between the cable actuating mechanism and the end effector.

12. The system of claim 5, wherein the marking tool comprises a material applicator.

13. The system of claim 12, further comprising a reservoir and pumping system positioned on the carrier or the carrier platform to deliver materials to the marking tools.

14. The robotic system of claim 1, further comprising one or more positional sensors positioned on the carrier or the carrier platform to provide relative positional feedback for a coordinated motion.

15. The system of claim 1, further comprising a fall protection mechanism positioned on the carrier platform to configured to inhibit the end effector from falling.

16. The system of claim 1, further comprising an anchoring mechanism on the carrier platform configured to provide fixtures to the carrier platform.

17. A method of facade operation of a building facade with an irregular surface, different features, and extrusions, the method comprising using the system of claim 9 to mark a specified area of the facade by the marking tool according to a feedback signal of the facade inspection sensor.

18. The method of claim 17, comprising coordinating the motion of the locomotion mechanism and the at least two cables for adaption of the system to building geometries.

19. The method of claim 18, comprising acquiring visual images of the building facade, converting the images into virtual models, and using the virtual models to guide the inspection and indicate one or more specific areas of interest for inspection.

20. The method of claim 19, comprising distributing one or more specific areas of interest for inspection into the virtual models of the building facade.
